(19) United States
(12) Patent Application Publication
(10) Pub. No.: US 2010/0042236 A1
(43) Pub. Date: Feb. 18, 2010

(54) Self-service terminal

(75) Inventor: Alan C. Chow, Duluth, GA (US)

Correspondence Address: MICHAEL CHAN;NCR CORPORATION, 1700 SOUTH PATTERSON BLVD, DAYTON, OH, 45479-0001, US

(73) Assignee: NCR Corporation

(21) Appl. No.: 12/228,714

(22) Filed: Aug. 15, 2008

(51) Int. Cl. G06F 17/00

(52) U.S. Cl. 700/94

(57) ABSTRACT

A self-service terminal (SST) and a method of operating the SST are described. The SST comprises a control application arranged to control operation of the SST. The control application is operable to play a first musical sequence on execution of an initial event at the terminal. The first musical sequence may comprise an arrangement of musical notes that serves as an audible indicator associated with a manufacturer of that terminal. A method of identifying a manufacturer of an SST by means of an audible indicator during a transaction at the SST is also described.

### FIELD OF INVENTION

The present invention relates to a self-service terminal (SST).

### BACKGROUND OF INVENTION

An SST is generally defined as a machine that is suitable for allowing a user to conduct a transaction or to access information in an unassisted manner (that is, without requiring help from a human) and/or in an unattended environment (that is, an area that may not be constantly supervised by someone to ensure that the SSTs are not being misused). An SST deployer may decide to provide human assistance and/or supervision for users of the SST; however, SSTs are typically designed so that such assistance and/or supervision is not essential.

There are many different manufacturers of SSTs. Some manufactures produce terminals that are robust, reliable, and resilient to misuse; other manufacturers produce terminals that fail during transactions and have to go out-of-service at regular intervals.

SSTs are typically branded in the corporate color scheme of a customer of the SST manufacturer, so there is limited scope for a manufacturer of high-quality SSTs to distinguish its SSTs from those of other manufacturers. This means that end-users of the SSTs cannot easily differentiate between potentially high quality and low quality SSTs.

It would be advantageous to be able to mitigate or overcome this problem.

### SUMMARY OF INVENTION

Accordingly, the invention generally provides methods, systems, apparatus, and software for creating brand loyalty and/or trust at an SST.

In addition to the Summary of Invention provided above and the subject matter disclosed below in the Detailed Description, the following paragraphs of this section are intended to provide further basis for alternative claim language for possible use during prosecution of this application, if required. If this application is granted, some aspects of the invention may relate to claims added during prosecution of this application, other aspects may relate to claims deleted during prosecution, other aspects may relate to subject matter never claimed. Furthermore, the various aspects detailed hereinafter are independent of each other, except where stated otherwise. Any claim corresponding to one aspect should not be construed as incorporating any element or feature of the other aspects unless explicitly stated in that claim.

According to a first aspect there is provided a self-service terminal comprising a control application arranged to control operation of the terminal, the control application being operable to play a first musical sequence on execution of an initial event at the terminal.

As used herein the word “musical” refers to audible sounds, which may be tones, beeps, or the like, but “musical” does not include spoken words. The word “musical” includes, but is not limited to, a harmonious non-speech sound, such as a tune.

The initial event may be (i) insertion by a customer of a card into a card reader of the terminal, (ii) presentation of a token (such as a card) to a token reader of the terminal, where the token reader may implement wireless communication (such as near field communication, Bluetooth (trade mark), one of the 802.11 series of communication protocols, inductive coupling, capaticive coupling, or the like), (iii) a customer pressing a selectable area (such as a key, button, or touch-sensitive area) on the terminal, (iv) a customer entering a monitored zone (which may be detected by, for example, a pressure sensitive pad, detecting someone standing or sitting, or a proximity sensor) in front of, or adjacent to, the terminal, (v) detection of a contactless token entering a monitored zone, (vi) detection of wireless signals transmitted to the self-service terminal, (vii) a customer presenting a part of his/her body to a biometrics reader, or (viii) any other convenient initial event.

The initial event, however, does not include the terminal booting up or loading an operating system. Similarly, configurable operating system sounds corresponding to actions taken, or events detected, by an operating system (such as closing a program, a new mail notification, or the like) do not constitute an initial event. An initial event requires some action to be taken by an end user (customer) of the terminal to initiate a transaction (which may be the customer, or a token carried by the customer, entering a monitored zone in the vicinity of the terminal). An initial event does not occur automatically. Therefore, playing of a musical sequence when the terminal boots up or when operating system software is loaded does not constitute playing a first musical sequence on execution of an initial event at the terminal.

The first musical sequence may be any arrangement of musical notes that serves as an audible indicator unique to a manufacturer of that terminal. The first musical sequence may be stored and played as a digital file, such as a .WAV file, an MP3 file, a .WMA file, an AVI file, or the like.

The first musical sequence may be resident on the terminal. For example, the first musical sequence may be stored as a file on a storage device (disk drive, NVRAM, removable media, or the like). Alternatively, the first musical sequence may be downloaded to the terminal. This may be implemented when the first musical sequence is associated with software downloaded from a remote host, rather than hardware on which the downloaded software will execute.

The first musical sequence may be accompanied by a graphic component, so that the first musical sequence is part of a first video sequence. The first video sequence may be presented on a small portion of a screen.

The term “screen” is used herein to denote software-generated, visual information, namely the graphics, text, controls (such as menu options), and such like, that are presented on an SST display; the term “screen” as used herein does not refer to the hardware (that is, the display) that presents the graphics, text, controls, and such like.

The control application may be operable to play a second musical sequence on execution of a closing event at the terminal.

The closing event may be (i) removal by a customer of a card from a card reader of the terminal, (ii) removal of a token from a token reader of the terminal, (iii) a customer pressing a selectable area (such as a key, button, or touch-sensitive area) on the terminal, (iv) absence of the customer from a monitored zone (for example, by moving off a pressure sensitive pad, or out of range of a proximity sensor) in front of, or adjacent to, the terminal, (v) detection of a contactless token leaving a monitored zone, (vi) detection of wireless signals transmitted to the self-service terminal indicative of a session closing, or (vii) any other convenient closing event.

The self-service terminal may be a public self-service terminal, such as an automated teller machine (ATM), an information kiosk, a financial services center, a ticketing kiosk, a merchandising kiosk, a bill payment kiosk, a lottery kiosk, a postal services machine, a check-in and/or check-out terminal such as those used in the retail, hotel, car rental, gaming, healthcare, rail, sea, and airline industries, or the like. In some embodiments, the self-service terminal may be a private self-service terminal, such as a home computer, a cellular radio-frequency telephone, a personal digital assistant or the like. A private self-service terminal is typically owned and used by a single person (a private individual); whereas a public self-service terminal is typically owned by a company and used by many different members of the public.

According to a second aspect there is provided a method of identifying a manufacturer of a self-service terminal during a transaction at the self-service terminal, where the self-service terminal is owned, operated, and branded by a third party, the method comprising: detecting an initial event at the terminal, and playing a first musical sequence in response to detecting the initial event.

The first musical sequence may comprise a sequence of notes, the middle note corresponding to middle C (C4 in scientific pitch notation) on the chromatic scale (corresponding approximately to 261.626 Hertz).

The method may further comprise: detecting a secure transaction selection, and playing a musical sequence in response to detection of the secure transaction. The secure transaction selection may be one of a plurality of transactions, some of which require a high level of security (for example, making purchases, effecting payment, transferring funds, withdrawing funds, entering personal information, and the like) and others may not require a high level of security (such as browsing the Web, accessing travel timetables, or the like). The secure transaction selection may be similar to a musical equivalent of a padlock icon that appears on a Web page when a secure server is being accessed. However, the musical sequence informs the end-user (through the end-user associating that musical sequence with secure and trustworthy transactions) that the secure transaction selection is being executed on apparatus or software supplied by a manufacturer that can be trusted.

The method may further comprise: detecting a closing event at the terminal, and playing a second musical sequence in response to detecting the closing event.

According to a third aspect of the invention there is provided a computer program comprising instructions for implementing all of the steps of the second aspect of the invention.

According to a fourth aspect there is provided a computer program downloadable to a self-service terminal in response to a request from the self-service terminal, the computer program comprising instructions for playing a first musical sequence when the computer program is executed by the self-service terminal.

This has the advantage that a user of a self-service terminal is assured by the first musical sequence that the downloaded computer program can be trusted.

The computer program may include a digital file containing the first musical sequence.

By virtue of these aspects of the invention, an audible sequence of notes is provided that enables an end-user of a terminal or software to recognize that the terminal or software was manufactured by a trustworthy manufacturer.

These and other aspects will be apparent from the following specific description, given by way of example, with reference to the accompanying drawings.

### BRIEF DESCRIPTION OF THE DRAWINGS

FIG. 1 is a simplified schematic diagram of a self-service terminal according to one embodiment of the present invention;

FIG. 2 is a block diagram of a part (the controller) of the terminal of FIG. 1;

FIG. 3 is a flowchart illustrating the operation of an application executing on the controller of FIG. 2; and

FIG. 4 is a simplified schematic diagram of a self-service terminal according to another embodiment of the present invention.

### DETAILED DESCRIPTION

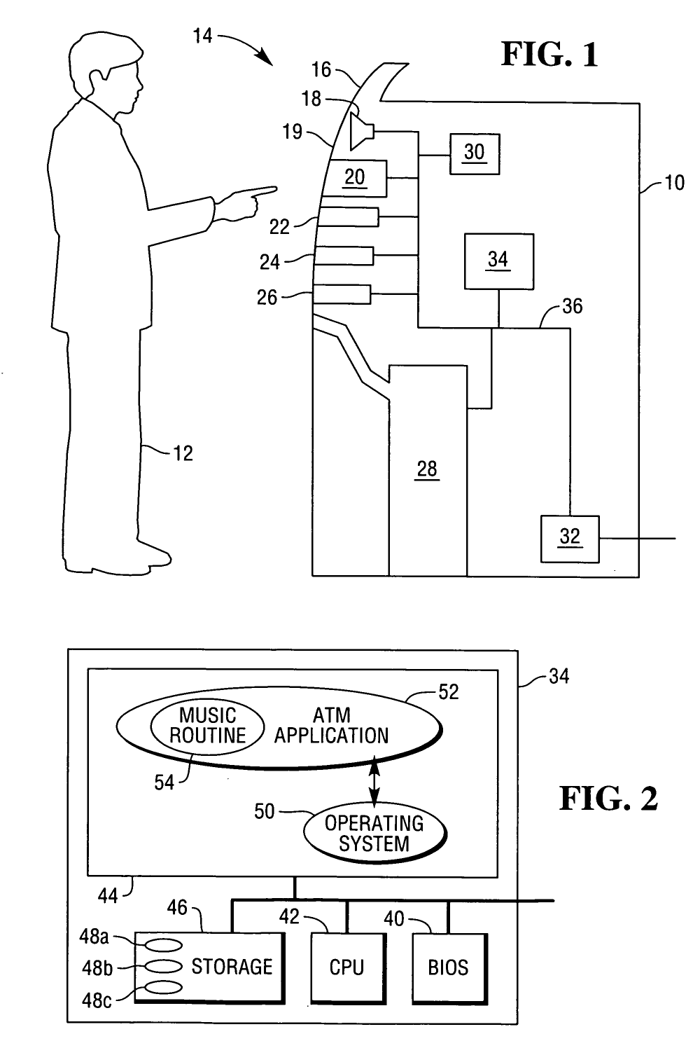

Reference is first made to FIG. 1, which is a side schematic view of a self-service terminal 10 (in the form of an ATM) being used by a customer 12 according to one embodiment of the present invention. In this embodiment, the ATM 10 is manufactured by the assignee of this application (NCR Corporation (trade mark)).

The ATM 10 includes a user interface 14 for receiving input (information and media) from, and providing output (information and media) to, the customer 12.

The user interface 14 comprises: a molded fascia 16 defining slots (not shown in detail) for accessing devices located within the ATM 10 and in registration with the slots; a loudspeaker 18 (located behind a grille 19 defined by the fascia 16); a display 20 aligned with opposing columns of function defined keys (FDKs); an encrypting keypad 22; a token reader 24, in the form of a motorized card reader/writer (MCRW) device; a receipt printer 26; and a media dispenser 28 in the form of a cash dispenser.

The ATM 10 also includes an internal journal printer 30 for creating a record of all transactions executed by the ATM 10, a network connection 32 (in the form of a network card) for communicating with a remote transaction host (not shown) for authorizing transactions, and an ATM controller 34 for controlling the operation of the various devices (18 to 32).

The ATM controller 34 is shown in more detail in FIG. 2. The controller 34 comprises a BIOS 40 stored in non-volatile memory, a microprocessor 42, associated main memory 44, and storage space 46 in the form of a disk drive. The disk drive 46 stores digital files 48 including a first musical sequence 48a, a second musical sequence 48b, a third musical sequence 48c, and the like. The digital files 48 are in the form of individual WAV files.

In use, the ATM 10 loads an operating system kernel 50 and an ATM application program 52 into the main memory 44. The ATM application program 52 includes conventional routines and objects for controlling the operation of the ATM 10, such as providing the sequence of screens used in each transaction (referred to as the application flow) and monitoring the condition of each device within the ATM 10 (state of health monitoring), as is known to those of skill in the art.

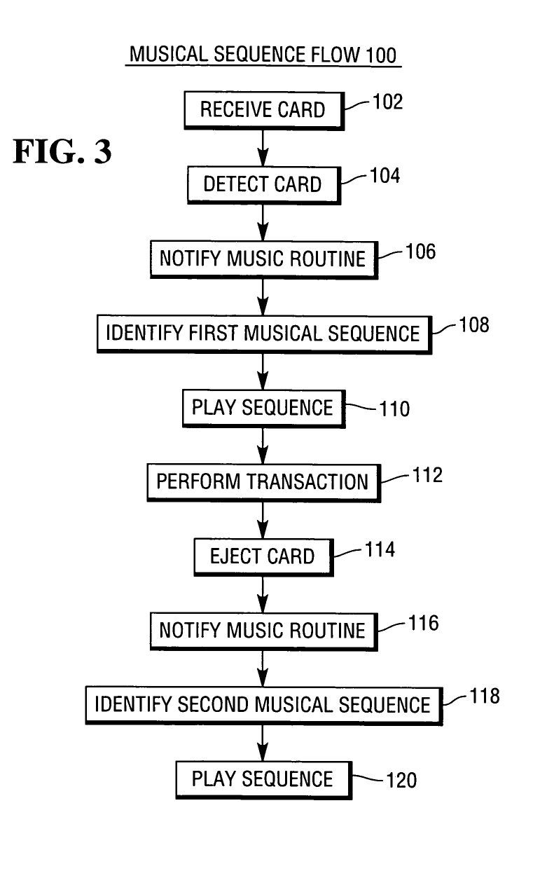

In addition to routines for implementing conventional ATM functions, the ATM application program 52 includes a musical sequence routine 54, the operation of which will now be described with reference to FIG. 3, which is a flowchart illustrating steps performed by the ATM 10 during a transaction (the musical sequence flow 100).

Initially, the customer 12 inserts an ATM card into the card reader slot on the user interface 14, and the card is received by the MCRW 24 (step 102). The card insertion is detected by the ATM 10 (step 104) (via the MCRW 24), and the ATM application program 52 informs the musical sequence routine 54 that an initial event has occurred (step 106).

The musical sequence routine 54 then identifies a first musical sequence which is associated with the initial event (step 108), which corresponds to the first musical WAV file 48a.

The musical sequence routine 54 plays the first musical WAV file 48a through the loudspeaker 18 (step 110). In this embodiment, the first musical sequence is simply three consecutive notes comprising the middle C chord played consecutively (in arpeggio) from lowest to highest note. In this embodiment, the instrument used to play the middle C chord is a piano because the manufacturer of the ATM 10 has chosen to use a piano sound as the first musical sequence on all of its ATMs.

The manufacturer may use a different musical instrument as the musical sequence on each type of self-service terminal it manufactures. For example, a guitar may be used for the musical sequences on a retail self-checkout terminal. This enables a customer to associate a musical sequence with the manufacturer, and to identify different types of self-service terminals based on the instrument used to play the musical sequences on that terminal.

The customer 12 hears this first musical sequence, which the customer 12 may recognize from a marketing campaign implemented by the ATM manufacturer. Hearing this first musical sequence should create confidence in the customer 12 that the manufacturer of the ATM 10 is reputable and the ATM 10 is trustworthy.

The transaction then proceeds as normal, with the customer 12 selecting whichever banking transaction is desired (step 112), which may involve dispensing cash to the customer 12.

Once the transaction has been completed, the ATM 10 ejects the customer's card (step 114). Removal of the card by the customer is detected by the ATM 10 (via the MCRW 24), and the ATM application program 52 informs the musical sequence routine 54 that a closing event has occurred (step 116).

The musical sequence routine 54 then identifies a second musical sequence which is associated with the closing event (step 118), which is the second WAV file 48b.

The musical sequence routine 54 then plays the identified second musical sequence through the loudspeaker 18 (step 120). In this embodiment, the second musical sequence is simply three notes comprising the middle C chord played simultaneously (as a chord).

This embodiment has the advantage that the customer 12 is able to conduct a transaction knowing that the ATM 10 has been provided by the manufacturer that provides those musical sequences, in this embodiment, NCR Corporation (trade mark).

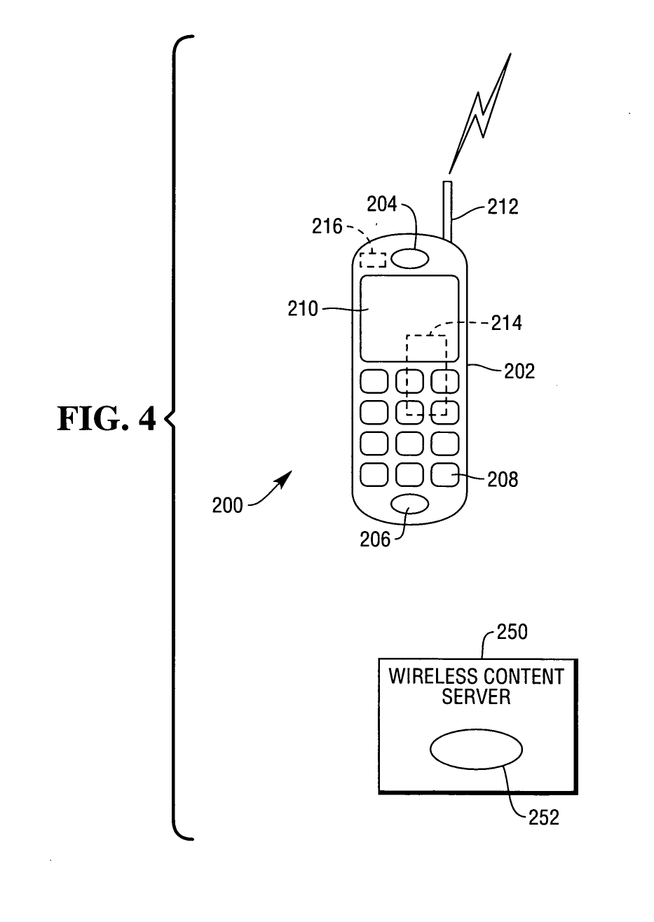

Another embodiment will now be described with reference to FIG. 4, which is a schematic diagram of a self-service terminal 200 in the form of a conventional cellular handheld device, which combines the functions of a cellular radio-frequency telephone and a personal digital assistant.

In this embodiment, the musical sequences are associated with software downloaded to the handheld device 200, not the handheld device 200 itself.

As illustrated in FIG. 4, the handheld device 200 comprises a body 202 housing a loudspeaker 204, a microphone 206, a keypad 208, a graphical display 210, an antenna 212, a controller 214 (shown in broken line), and a local communication port 216 (such as a Bluetooth port, an IrDA port, an NFC port, or the like).

A user of the handheld device 200 can access online content from a wireless content server 250 using a micro-browser executing on the controller 214. As part of a secure transaction (for example a financial transaction), the user can download software (illustrated by ellipse 252 in FIG. 4). The downloaded software 252 may be, for example, in the form of applets or COM objects. The user can then use the downloaded software 252 to enter transaction details.

The server 250 transmits the software 252 in response to a request from the micro-browser. When the software 252 is downloaded to the handheld device 200, the software automatically plays a first musical sequence (from a digital file incorporated in the software 252) through the loudspeaker 204 so that the user of the handheld device 200 will know that the software can be trusted. As in the previous example, the musical sequence may be a simple sequence of notes, or a more complicated arrangement (including chords).

It should now be appreciated that these embodiments have the advantage of being able to inform a user of a terminal that the terminal itself or software downloaded to the terminal is from a known, and trustworthy, source.

Various modifications may be made to the above described embodiment within the scope of the invention, for example, in other embodiments different self-service terminals may be used to those described. In other embodiments, the musical sequences may be different to those described. For example, individual musical notes may be used, different chords may be used to those described above, a combination of notes and chords may be used, or any other convenient arrangement may be used.

The sequences may be recorded as a digital file or may be generated on-the-fly by the terminal. Where a digital file is used, any convenient file format, or a variety of file formats, may be employed.

The customer identification process described above for the first embodiment is based on a customer inserting a card into a card reader. In other embodiments, any convenient customer identification process may be used, including: biometrics, a proximity token, or the like.

The steps of the methods described herein may be carried out in any suitable order, or simultaneously where appropriate. The methods described herein may be performed by software in machine readable form on a tangible storage medium or as a propagating signal.

The terms “comprising”, “including”, “incorporating”, and “having” are used herein to recite an open-ended list of one or more elements or steps, not a closed list. When such terms are used, those elements or steps recited in the list are not exclusive of other elements or steps that may be added to the list.

What is claimed is:

1. A self-service terminal comprising a control application arranged to control operation of the terminal, the control application being operable to play a first musical sequence on execution of an initial event at the terminal.

2. A self-service terminal according to claim 1, wherein the initial event comprises insertion by a customer of a card into a card reader of the terminal.

3. A self-service terminal according to claim 1, wherein the first musical sequence comprises an arrangement of musical notes that serves as an audible indicator unique to a manufacturer of that terminal.

4. A self-service terminal according to claim 3, wherein the first musical sequence is stored and played as a digital file.

5. A self-service terminal according to claim 3, wherein the first musical sequence is generated on-the-fly by the terminal.

6. A self-service terminal according to claim 1, wherein the first musical sequence is resident on the terminal.

7. A self-service terminal according to claim 1, wherein the first musical sequence is downloaded to the terminal.

8. A self-service terminal according to claim 1, wherein the first musical sequence is accompanied by a graphic component, so that the first musical sequence is part of a first video sequence.

9. A self-service terminal according to claim 1, wherein the control application is operable to play a second musical sequence on execution of a closing event at the terminal.

10. A self-service terminal according to claim 1, wherein the closing event comprises removal by a customer of a card from a card reader of the terminal.

11. A method of identifying a manufacturer of a self-service terminal during a transaction at the self-service terminal, where the self-service terminal is owned, operated, and branded by a third party, the method comprising:
detecting an initial event at the terminal; and
playing a first musical sequence in response to detecting the initial event.

12. A method according to claim 11, wherein the first musical sequence comprises a sequence of notes, including a note corresponding approximately to 261 Hertz.

13. A method according to claim 11, wherein the method may further comprise:
detecting a secure transaction selection; and
playing a musical sequence in response to detection of the secure transaction.

14. A method according to claim 13, wherein the secure transaction selection comprises one of a plurality of transactions, some of which require a high level of security and others not requiring a high level of security.

15. A computer program comprising instructions for implementing all of the steps of claim 11.
